(19) United States
(12) Patent Application Publication
(10) Pub. No.: US 2021/0287394 A1
(43) Pub. Date: Sep. 16, 2021

(54) BEAUTY PROCESSING METHOD, DEVICE, UNMANNED AERIAL VEHICLE, AND HANDHELD GIMBAL

(71) Applicant: SZ DJI TECHNOLOGY CO., LTD., Shenzhen (CN)

(72) Inventors: Chengqun ZHONG, Shenzhen (CN); Gaoping BAI, Shenzhen (CN)

(21) Appl. No.: 17/116,600

(22) Filed: Dec. 9, 2020

Related U.S. Application Data
(63) Continuation of application No. PCT/CN2018/092310, filed on Jun. 22, 2018.

(51) Int. Cl. G06T 7/73; G06K 9/00; H04N 9/64; G06K 9/62

(52) U.S. Cl. CPC G06T 7/73; G06K 9/00275; G06T 2207/30201; G06K 9/6253; H04N 9/643

(57) ABSTRACT

A beauty processing method includes obtaining tracking information of a target object in a to-be-processed image, the tracking information including feature information of the target object, and performing beauty processing on the target object according to the feature information of the target object.

### CROSS-REFERENCE TO RELATED APPLICATION

This application is a continuation of International Application No. PCT/CN2018/092310, filed Jun. 22, 2018, the entire content of which is incorporated herein by reference.

### TECHNICAL FIELD

The present disclosure generally relates to the image processing technology field and, more particularly, to a beauty processing method, device, unmanned aerial vehicle (UAV), and handheld gimbal.

### BACKGROUND

With the continuous development of the image processing technology, for a device having a photographing function or a recording function, before displaying an image for a user, the device may first perform beauty processing on the image and display the image after the beauty processing for the user to view.

In the existing technology, when the device performs the beauty processing on the image, the device needs to first perform human face recognition on the image to determine human face information of the image and extract relevant feature information of eyes, nose, mouth, etc. Then, the device may perform post-processing such as maintaining edges, blurring impurities, and bilateral filters on the face to achieve an effect of beauty.

However, the existing beauty processing method does not have a high efficiency of beauty processing.

### SUMMARY

Embodiments of the present disclosure provide a beauty processing method. The method includes obtaining tracking information of a target object in a to-be-processed image, the tracking information including feature information of the target object, and performing beauty processing on the target object according to the feature information of the target object.

Embodiments of the present disclosure provide a beauty processing device including a memory and a processor. The memory stores a program instruction. The processor is configured to obtain tracking information of a target object in a to-be-processed image, the tracking information including feature information of the target object, and perform beauty processing on the target object according to the feature information of the target object.

Embodiments of the present disclosure provide a handheld gimbal including a beauty processing device. The beauty processing device includes a memory and a processor. The memory stores a program instruction. The processor is configured to obtain tracking information of a target object in a to-be-processed image, the tracking information including feature information of the target object, and perform beauty processing on the target object according to the feature information of the target object.

### BRIEF DESCRIPTION OF THE DRAWINGS

FIG. 1 is a schematic flowchart of a beauty processing method according to some embodiments of the present disclosure.

FIG. 2 is a schematic flowchart of another beauty processing method according to some embodiments of the present disclosure.

FIG. 3 is a schematic diagram of determining a target object according to some embodiments of the present disclosure.

FIG. 4 is a schematic structural diagram of a beauty processing device according to some embodiments of the present disclosure.

FIG. 5 is a schematic structural diagram of an unmanned aerial vehicle (UAV) according to some embodiments of the present disclosure.

FIG. 6 is a schematic structural diagram of a handheld gimbal according to some embodiments of the present disclosure.

### DETAILED DESCRIPTION OF THE EMBODIMENTS

To make purposes, technical solutions, and advantages of embodiments of the present disclosure clearer, the technical solutions of embodiments of the present disclosure are described in detail in connection with the accompanying drawings. Described embodiments are some embodiments of the present disclosure, not all embodiments. Based on embodiments of the present disclosure, all other embodiments obtained by those skilled in the art without creative efforts are within the scope of the present disclosure. With no conflict, features of embodiments may be combined with each other.

A beauty processing method consistent with embodiments of the present disclosure may be applied to devices of an unmanned aerial vehicle (UAV), a handheld gimbal, a remote controller, etc. For example, when a user uses the UAV to record a video of a target object, tracking information of the target object may be obtained directly through tracking by the UAV. Since the tracking information may include feature information of the target object, the UAV may directly perform beauty processing on the target object according to the feature information of the target object to realize the beauty processing of the target object. After obtaining the tracking information of the target object through tracking, the UAV may transmit the tracking information of the target object to a terminal device connected to the UAV. As such, the terminal device may directly perform the beauty processing on the target object according to the feature information of the target object to realize the beauty processing of the target object. Therefore, the beauty processing method consistent with embodiments of the present disclosure does not need to perform human face recognition on a to-be-processed image and extract human face feature information of the to-be-processed image. Thus, the efficiency of the beauty processing can be improved.

The technical solution of the present disclosure and how the technical solution of the present disclosure solves the above technical problem are described in detail in specific embodiments. Specific embodiments may be combined with each other. A same or similar concept or process is not repeated in some embodiments. Embodiments of the present disclosure are described in connection with the accompanying drawings.

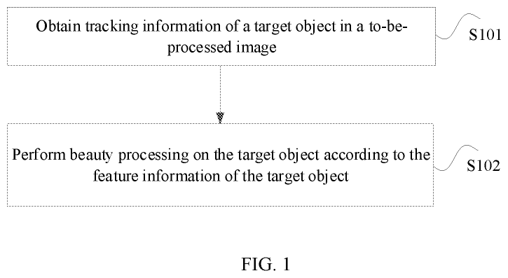

FIG. 1 is a schematic flowchart of a beauty processing method according to some embodiments of the present disclosure. Referring to FIG. 1, the beauty processing method includes the following processes.

At S101, tracking information of a target object in a to-be-processed image is obtained.

The tracking information may include feature information of the target object. In some embodiments, the target object may include a human, an animal, or a scene. In embodiments of the present disclosure, when the target object is human, the feature information of the target object may include at least one of position information of the target object in the to-be-processed image, facial feature information, or face profile information. Further, the facial feature information may include an eye bow characteristic, an eye characteristic, a nose characteristic, a mouth characteristic, and an ear characteristic of the target object.

In some embodiments, for example, the position information of the target object in the to-be-processed image may be represented by a coordinate point. When the position information of the target object in the to-be-processed image is represented by the coordinate point, a center point of a recording screen may be used as a coordinate origin, or other points may also be used as the coordinate origin. In embodiments of the present disclosure, the center point of the recording screen is described as an example of the coordinate origin only, which does not mean that embodiments of the present disclosure are limited to this.

In some embodiments, the feature information of the target object may only include any one of the position information of the target object in the to-be-processed image, the facial feature information, and the face profile information. The feature information of the target object may also include any two of the position information of the target object in the to-be-processed image, the facial feature information, and the face profile information. The feature information of the target object may also include all the position information of the target object in the to-be-processed image, the facial feature information, and the face profile information. The feature information of the target object may further include an expression of the target object. In embodiments of the present disclosure, the feature information of the target object including at least one of the position information of the target object in the to-be-processed image, the facial feature information, or the face profile information is described as an example only, which does not mean that embodiments of the present disclosure are limited to this.

After the feature information of the target object in the to-be-processed image is obtained, process S102 may be executed.

At S102, beauty processing is performed on the target object according to the feature information of the target object.

In some embodiments, the beauty processing may include at least one of skin smooth processing, skin color change processing, or whitening processing.

The skin smooth processing may be understood to polish skin to cause rough skin to become smoother. The skin color change processing may be understood to change skin color to cause the skin color to become brighter. The whitening processing may be understood to whiten the skin to cause the skin to become whiter. Besides the skin smooth processing, the skin color change processing, and/or the whitening processing, the beauty processing may further include other beauty processing of face-lifting processing, heightening processing, wrinkle removal processing, bright eye processing, eye enlargement processing, etc. The above beauty processing is described as an example in embodiments of the present disclosure, which does not limit embodiments of the present disclosure.

In embodiments of the present disclosure, only the target object being human and the beauty processing performed on the human of the image are described as an example. In some other embodiments, the target object may also include a scene. When the beauty processing is performed on the scene, the beauty processing may include one or more beauty modes of brightness processing, contrast processing, saturation processing, sharpening processing, color temperature processing, light and shade adjustment processing, etc.

After the feature information of the target object is obtained at S101, the beauty processing may be directly performed on the target object according to the feature information of the target object. The beauty processing method consistent with embodiments of the present disclosure does not need to perform human face recognition on the to-be-processed image and extract the feature information of the human face in the to-be-processed image. Therefore, the efficiency of the beauty processing can be improved.

According to the beauty processing method consistent with embodiments of the present disclosure, when the beauty processing is performed on the target object, the tracking information of the target object may be directly obtained. Since the tracking information may include the feature information of the target object, after the feature information of the target object is obtained, the beauty processing may be performed directly on the target object according to the feature information of the target object to realize the beauty processing of the target object. The beauty processing method consistent with embodiments of the present disclosure does not need to perform the human face recognition on the to-be-processed image and extract the feature information of the human face in the to-be-processed image. Therefore, the efficiency of the beauty processing can be improved.

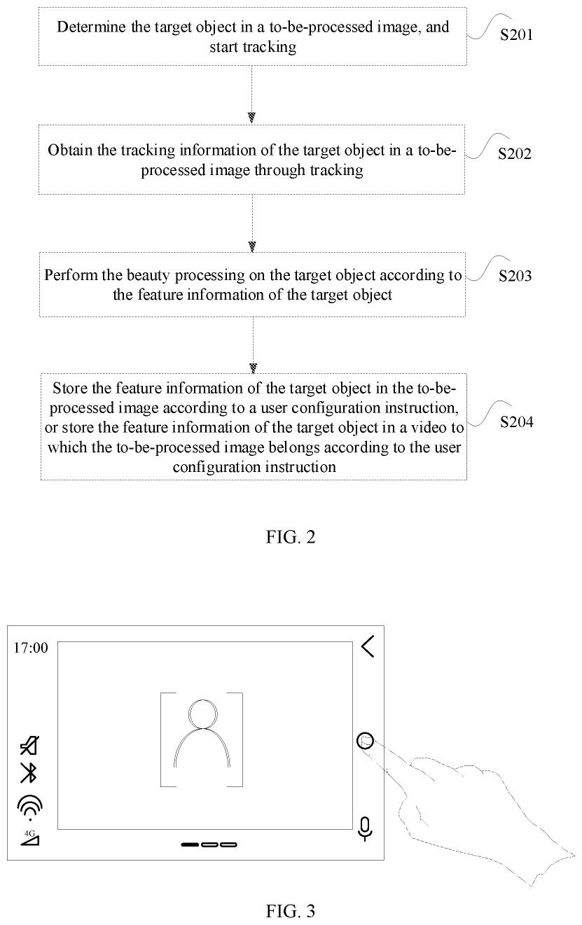

Based on embodiments shown in FIG. 1, the beauty processing method consistent with embodiments of the present disclosure is further described clearer as shown in FIG. 2. FIG. 2 is a schematic flowchart of another beauty processing method according to some embodiments of the present disclosure. The beauty processing method further includes the following processes.

At S201, the target object in the to-be-processed image is determined, and tracking is started.

Tracking is a technology based on visual tracking, which may be implemented by software codes. In some embodiments, the software codes may be integrated into a processor to track the target object.

For example, FIG. 3 is a schematic diagram of determining a target object according to some embodiments of the present disclosure. When the target object is determined to be John, an image of John may be enclosed in a target frame of the recording screen to determine that John in the target frame is the to-be-tracked target object. After John is determined to be the target object, tracking may be started to track John. For example, in embodiments of the present disclosure, tracking may be started by clicking a start button for tracking, or may be triggered to start by voice input, or may be started by a gesture (no touch on a display). The above-described manners are merely examples described in embodiments of the present disclosure and do not limit embodiments of the present disclosure.

After determining the target object in the to-be-processed image and starting tracking at S201, process S202 is performed.

At S202, the tracking information of the target object in the to-be-processed image is obtained through tracking.

In some embodiments, the feature information of the target object in the to-be-processed image may be calculated through tracking.

The tracking information may include the feature information of the target object. In some embodiments, the feature information of the target object may include at least one of the position information of the target object in the to-be-processed image, the facial feature information, or the face profile information. The feature information of the target object may further include the expression of the target object. In embodiments of the present disclosure, only the feature information of the target object including at least one of the position information of the target object in the to-be-processed image, the facial feature information, or the face profile information is described as an example. However, embodiments of the present disclosure are not limited to this.

When the tracking information of the target object in the to-be-processed image is obtained by tracking, an unmanned aerial vehicle (UAV) may move to follow the target object and compose an image to cause the position of the target object to be maintained the same relative to the target frame of the recording screen. The UAV may further calculate the feature information of the target object in each frame image through tracking to obtain the feature information of the target object in the to-be-processed image.

When the tracking information of the target object in the to-be-processed image is obtained, the tracking information of the target object in the to-be-processed image may be obtained during the video recording. For example, for the UAV, during the video recording (e.g., photographing with the beauty processing), after the tracking information of the target object in the to-be-processed image is obtained, process S203 may be executed. The beauty processing may be performed directly according to the feature information of the target object included in the tracking information to output an image after the beauty processing. After obtaining the tracking information of the target object in the to-be-processed image, the UAV may not perform the beauty processing according to the feature information of the target object included in the tracking information but execute process S204. The obtained tracking information may be stored, when the beauty processing is subsequently performed on the to-be-processed image, the pre-stored tracking information may be looked up, and the beauty processing may be performed according to the feature information of the target object included in the tracking information.

At S203, the beauty processing is performed on the target object according to the feature information of the target object.

In some embodiments, the beauty processing may include at least one of the skin smooth processing, the skin color change processing, or the whitening processing. Besides the skin smooth processing, the skin color change processing, and/or the whitening processing, the beauty processing may further include the face-lifting processing, the heightening processing, the wrinkle removal processing, the bright eye processing, the eye enlargement processing, etc. In embodiments of the present disclosure, only the above processing is described as an example. However, embodiments of the present disclosure are not limited to this.

After the tracking information of the target object in the to-be-processed image is obtained through tracking at S202, the beauty processing may be performed on the target object directly according to the feature information of the target object. The beauty processing method consistent with embodiments of the present disclosure does not need to perform the human face recognition on the to-be-processed image and extract the feature information of the human face of the to-be-processed image. Therefore, the efficiency of the beauty processing can be improved.

Further, after the feature information of the target object in the to-be-processed image is obtained, the beauty processing may not be performed according to the feature information of the target object included in the tracking information, but the feature information of the target object may be stored, that is, process S204 may be executed.

At S204, the feature information of the target object is stored in the to-be-processed image according to a user configuration instruction, or the feature information of the target object is stored in a video to which the to-be-processed image belongs according to the user configuration instruction.

For example, when the user configuration instruction is received, if the user configuration instruction instructs to store the feature information of the target object, and the to-be-processed image is a picture, the feature information of the target object may be stored in an extreme memory profile (XMP) of the to-be-processed image. If the user configuration instruction instructs to store the feature information of the target object, and the to-be-processed image is a video, the feature information of the target object may be stored in subtitle text of the video to which the to-be-processed image belongs or in metadata of the video. The feature information of the target object may also be stored individually in a file, and a mapping relationship may be built between the feature information of the target object and the corresponding to-be-processed image in the file.

In embodiments of the present disclosure, after the feature information of the target object is stored, the stored feature information of the target object may be transmitted to an application (APP) of a terminal device via wifi, a universal serial bus (USB), or another online transmission manner. Thus, the terminal device may further perform the beauty processing on the target object according to the feature information of the target object. When performing the beauty processing on the target object, the terminal device may perform the beauty processing on the target object directly according to the feature information of the target object to realize the beauty processing of the target object. The beauty processing method consistent with embodiments of the present disclosure does not need to perform the human face recognition and extract the feature information of the human face of the to-be-processed image. Therefore, the efficiency of the beauty processing can be improved.

In embodiments of the present disclosure, there is no order between processes S203 and S204. Process S203 may be executed first, then process S204 may be executed, or process S204 may be executed first, then process S203 may be executed, or process S203 and process S204 may be executed simultaneously. In embodiments of the present disclosure, the method of executing process S203 first and then process S204 is described as an example. However, embodiments of the present disclosure are not limited to this.

During practical applications, when photographing with the beauty processing is performed, the target object in the to-be-processed image may be determined first, and then tracking may be started by clicking the start button for tracking. After tracking is started, the tracking information of the target object in the to-be-processed image may be obtained through tracking during the video recording. Since the tracking information includes the feature information of the target object, the beauty processing may be performed on the target object directly according to the feature information of the target object after the feature information of the target object is obtained to realize the beauty processing of the target object. The beauty processing method consistent with embodiments of the present disclosure does not need to perform the human face recognition on the to-be-processed image and extract the feature information of the human face of the to-be-processed image. Therefore, the efficiency of the beauty processing can be improved.

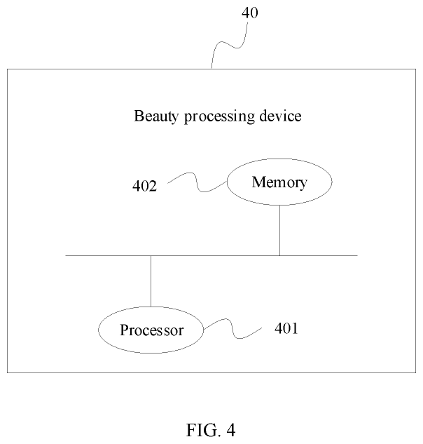

FIG. 4 is a schematic structural diagram of a beauty processing device 40 according to some embodiments of the present disclosure. As shown in FIG. 4, the beauty processing device 10 includes a processor 401 and a memory 402.

The memory 402 may be configured to store a program instruction.

The processor 401 may be configured to obtain the tracking information of the target object in the to-be-processed image. The tracking information may include the feature information of the target object.

The processor 401 may be further configured to perform the beauty processing on the target object according to the feature information of the target object.

In some embodiments, the feature information of the target object may include at least one of the position information of the target object in the to-be-processed image, the facial feature information, or the face profile information.

In some embodiments, the processor 401 may be configured to perform the beauty processing on the target object according to the feature information of the target object. The beauty processing may include at least one of the skin smooth processing, the skin color change processing, or the whitening processing.

In some embodiments, the processor 401 may be further configured to determine the target object in the to-be-processed image and start tracking.

The processor 401 may be configured to obtain the tracking information of the target object by tracking.

In some embodiments, the processor 401 may be configured to calculate the feature information of the target object in the to-be-processed image by tracking.

In some embodiments, the processor 401 may be configured to obtain the tracking information of the target object in the to-be-processed image during the video recording.

In some embodiments, the processor 401 may be further configured to store the feature information of the target object in the to-be-processed image according to the user configuration instruction or store the feature information of the target object in the video to which the to-be-processed image belongs according to the user configuration instruction.

In some embodiments, the processor 401 may be configured to store the feature information of the target object in the XMP of the to-be-processed image according to the user configuration instruction.

In some embodiments, the processor 401 may be configured to store the feature information of the target object in the subtitle text or the metadata of the video to which the to-be-processed image belongs.

The beauty processing device 40 may execute the technical solutions of any of the above-described beauty processing methods. The beauty processing device 40 may include similar implementation principles and technical effects, which are not repeated here.

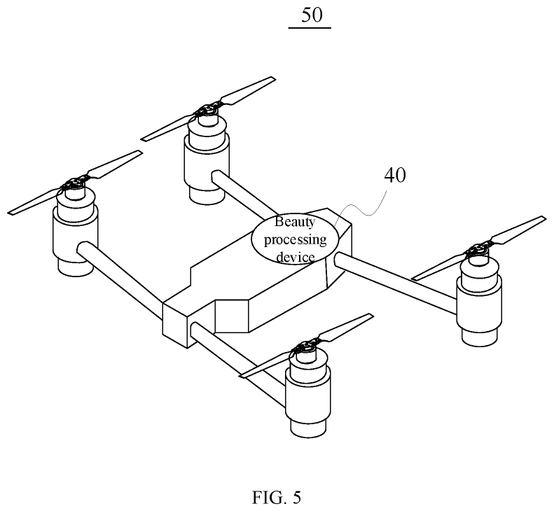

FIG. 5 is a schematic structural diagram of an unmanned aerial vehicle (UAV) 50 according to some embodiments of the present disclosure. As shown in FIG. 5, the UAV 50 includes the beauty processing device 40. The implementation principles and the technical effects of the UAV 50 may be similar to the implementation principles and the technical effects of the beauty processing method, which are not repeated here.

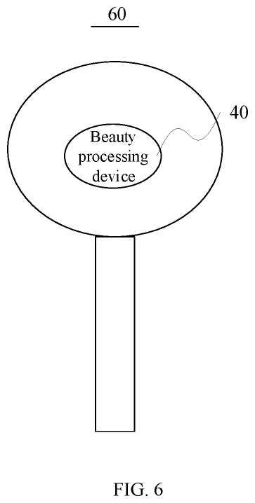

FIG. 6 is a schematic structural diagram of a handheld gimbal 60 according to some embodiments of the present disclosure. As shown in FIG. 6, the handheld gimbal 60 includes the beauty processing device 40. The implementation principles and the technical effects of the handheld gimbal 60 may be similar to the implementation principles and the technical effects of the beauty processing method, which are not repeated here.

Embodiments of the present disclosure further provide a computer-readable storage medium. The computer-readable storage medium may store a computer program, when the computer program is executed, the beauty processing method may be performed. The implementation principles and the technical effects may be similar to the implementation principles and the technical effects of the beauty processing method, which are not repeated here.

Embodiments of the present disclosure are merely used to describe the technical solutions of the present disclosure but not to limit the present disclosure. Although the present disclosure is described in detail with reference to embodiments of the present disclosure, those of ordinary skill in the art should understand that the modifications may still be performed on the technical solution described in embodiments of the present disclosure or equivalent replacements may be performed on some or all technical features. All these modifications and equivalent replacements do not cause the essence of the related technical solutions to depart from the scope of the technical solutions of embodiments of the present disclosure.

What is claimed is:

1. A beauty processing method comprising:
obtaining tracking information of a target object in a to-be-processed image, the tracking information including feature information of the target object; and
performing beauty processing on the target object according to the feature information of the target object.

2. The method of claim 1, wherein:
the feature information of the target object includes at least one of position information of the target object in the to-be-processed image, facial feature information, or human face profile information.

3. The method of claim 2, wherein:
performing the beauty processing on the target object according to the feature information of the target object includes performing at least one of skin smooth processing, skin color change processing, or whitening processing on the target object according to the feature information of the target object.

4. The method of claim 1, further comprising, before obtaining the tracking information of the target object in the to-be-processed image:
determining the target object in the to-be-processed image and starting tracking;
wherein obtaining the tracking information of the target object in the to-be-processed image includes obtaining the tracking information of the target object through tracking the target object.

5. The method of claim 4, wherein obtaining the tracking information of the target object through tracking the target object includes:
calculating the feature information of the target object in the to-be-processed image through tracking.

6. The method of claim 1, wherein obtaining the tracking information of the target object in the to-be-processed image includes:
obtaining the tracking information of the target object in the to-be-processed image during video recording.

7. The method of claim 1, further comprising, after obtaining the tracking information of the target object in the to-be-processed image:
storing the feature information of the target object in the to-be-processed image or in a video to which the to-be-processed image belongs according to a user configuration instruction.

8. The method of claim 7, wherein storing the feature information of the target object in the to-be-processed image according to the user configuration instruction includes:
storing the feature information of the target object in an extreme memory profile (XMP) of the to-be-processed image according to the user configuration instruction.

9. The method of claim 7, wherein storing the feature information of the target object in the video to which the to-be-processed image belongs according to the user configuration instruction includes:
storing the feature information of the target object in subtitle text or metadata of the video to which the to-be-processed image belongs according to the user configuration instruction.

10. A beauty processing device comprising:
a memory storing a program instruction; and
a processor configured to:
obtain tracking information of a target object in a to-be-processed image, the tracking information including feature information of the target object; and
perform beauty processing on the target object according to the feature information of the target object.

11. The device of claim 10, wherein:
the feature information of the target object includes at least one of position information of the target object in the to-be-processed image, facial feature information, or human face profile information.

12. The device of claim 11, wherein:
the processor is configured to perform at least one of skin smooth processing, skin color change processing, or whitening processing on the target object according to the feature information of the target object.

13. The device of claim 10, wherein the processor is further configured to:
determine the target object in the to-be-processed image and start tracking; and
obtain the tracking information of the target object through tracking the target object.

14. The device of claim 13, wherein the processor is configured to:
calculate the feature information of the target object in the to-be-processed image through tracking.

15. The device of claim 10, wherein the processor is configured to:
obtain the tracking information of the target object in the to-be-processed image during video recording.

16. The device of the claim 10, wherein the processor is further configured to:
store the feature information of the target object in the to-be-processed image or in a video to which the to-be-processed image belongs according to a user configuration instruction.

17. The device of claim 16, wherein the processor is configured to:
store the feature information of the target object in an extreme memory profile (XMP) of the to-be-processed image according to the user configuration instruction.

18. The device of claim 16, wherein the processor is configured to:
store the feature information of the target object in subtitle text or metadata of the video to which the to-be-processed image belongs according to the user configuration instruction.

19. A handheld gimbal comprising a beauty processing device including:
a memory storing a program instruction; and
a processor configured to:
obtain tracking information of a target object in a to-be-processed image, the tracking information including feature information of the target object; and
perform beauty processing on the target object according to the feature information of the target object.

20. The handheld gimbal of claim 19, wherein the processor is configured to:
obtain the tracking information of the target object in the to-be-processed image during video recording.
